(19) United States
(12) Patent Application Publication
(10) Pub. No.: US 2010/0319145 A1
(43) Pub. Date: Dec. 23, 2010

(54) TRANSMITTING DATA BETWEEN A TOOTHBRUSH AND A TERMINAL

(75) Inventors: Christian Neyer, Eschborn (DE); Alexander Hilscher, Konigstein/Taunus (DE); Matthias Schiebahn, Bad Camberg (DE)

Correspondence Address: FISH & RICHARDSON P.C. (BO), P.O. BOX 1022, MINNEAPOLIS, MN, 55440-1022, US

(73) Assignee: BRAUN GMBH, Kronberg/Taunus (DE)

(21) Appl. No.: 12/517,957

(22) PCT Filed: Oct. 20, 2007
(86) PCT No.: PCT/EP2007/009115

§ 371 Date: Jun. 5, 2009

(30) Foreign Application Priority Data
Dec. 6, 2006 (DE) 10 2006 057 492.3

(51) Int. Cl. A46B 13/00; G06F 13/10

(52) U.S. Cl. 15/22.1; 710/33

(57) ABSTRACT

Data is transmitted between an electric toothbrush and an external terminal, for example, a data processing and/or display unit, in some cases through an adapter connected to the toothbrush handle in place of a releasable attachment such as a brush head or application substance container. In some cases the data is transmitted wirelessly, such as in accordance to a wireless USB standard.

### TECHNICAL FIELD

The present invention relates to methods of transmitting data between a toothbrush and an external terminal, e.g., a data processing and/or display unit, and to an adapter, toothbrush and terminal configured for such transmission.

### BACKGROUND

DE 20 2005 003 516 U1 describes an electric toothbrush having a USB interface, by which the toothbrush can be connected to a computer to play music files in MP3 format in the toothbrush, so that these files can be played by the toothbrush when it is in use.

DE 197 45 551 A1 describes a toothbrush whose handle part can be connected to an examination head with a video camera and an ultrasonic device for examination of the teeth. A cable connection is provided on the handle of the toothbrush to transmit the images generated by the examination head to a display screen. Furthermore, DE 100 01 502 A1 describes a tooth-brush whose handle has a special interface for data communication with a computer. Tooth-cleaning data detected by motion sensors and pressure sensors are to be transmitted to the computer in this way to control a game displayed on a display screen by the computer.

WO 03/054771 A1 describes an electric toothbrush whose handle has a data transmission interface for communication with a transponder present in the attachable brush. Information stored in the transponder in the attachable brush can be entered into a microcontroller in the toothbrush handle in this way. WO 2006/069644 A1 describes how data, e.g., a tooth-brushing time that has been determined, can be written to a data memory provided in an attachable brush from the toothbrush handle. DE 10 2005 063 196.7 describes how data is transmitted from an electric toothbrush to a data medium on an application substance container.

### SUMMARY

Various aspects of the invention feature an adapter, a method for data transmission of the aforementioned type, and an electric toothbrush suitable for this purpose, which enable data communication between an electric toothbrush and an electronic data processing and/or display unit with simple means.

One aspect of the invention features an electric toothbrush and communication system, including a motorized toothbrush handle and a toothbrush data transmission adapter. The toothbrush handle has a releasable coupling configured to receive a replaceable toothbrush attachment, and a data transmission interface configured for data communication between the handle and the attachment. The adapter includes a toothbrush coupling configured to be coupled with the handle so as to communicate with the data transmission interface of the toothbrush handle, and a terminal interface in communication with the toothbrush coupling and configured to connect to an external terminal to enable data transmission between the toothbrush handle and the terminal.

Another aspect of the invention features a toothbrush data transmission adapter, having a toothbrush coupling and a terminal interface. The toothbrush coupling is configured to be coupled with an electric toothbrush handle having a data transmission interface configured to communicate with a replaceable toothbrush attachment, and includes a toothbrush data interface configured to communicate with a data transmission interface of a toothbrush handle to which the coupling is coupled. The terminal interface is in communication with the toothbrush coupling and configured to connect to an external terminal to enable data transmission between the toothbrush handle and the terminal.

Another aspect of the invention provides a method of transmitting data between an electric toothbrush handle and a terminal. The method includes connecting the toothbrush handle to the terminal via a data coupling that includes a coil in the toothbrush handle and a corresponding coil external to the toothbrush, and establishing data communication between the handle and the terminal through the data coupling.

In some applications, the adapter is attached to an electric toothbrush with a handle to which can be attached an attachable brush and/or to which an application substance container can be connected, and which has a data transmission unit with an interface for data transmission between the handle and the attachable brush and/or the application substance container. In some examples of data communication between an external terminal and the toothbrush, an existing interface provided for data transmission between the handle of the toothbrush and the attachable brush and/or the application substance container, is used. In some cases the adapter may be connected to the toothbrush, preferably its handle, and has a toothbrush interface adapted to the existing interface of the toothbrush. Thus it is not necessary to additionally provide on the toothbrush a specific data transmission interface that is compatible with the external terminal.

The interface of the toothbrush and the toothbrush interface of the adapter are preferably designed to work in a non-contact manner. For example, the toothbrush handle may have a data receiver/transmitter with an antenna coil suitable for communication with a transponder chip on the attachable brush and/or the application substance container. To be able to communicate with this data transmitter/receiver of the toothbrush handle, the toothbrush interface of the adapter is preferably provided with suitable data transmission means and with an antenna coil. Furthermore, the adapter may have a terminal interface that differs from the toothbrush interface and is PC-compatible, for example. The terminal interface of the adapter may be a USB interface or a wireless USB interface.

To achieve simple handling of the adapter and reliable data transmission, the toothbrush interface of the adapter may have a releasable fastening adapted in shape to an attachable brush coupling part of the toothbrush handle. Instead of attaching the attachable brush, the adapter can easily be attached to the attachable brush coupling part of the toothbrush handle in this way. The non-contact data receiver/transmitter may also be integrated, like the fastening, into a coupling piece that can be attached to the coupling piece on the handle for the attachable brush in a form-fitting and/or frictionally locked manner. In this way the data receiver/transmitter of the adapter is brought into a defined arrangement with respect to the data receiver/transmitter in the handle. The situation is also similar for the connection of the adapter to an application substance container coupling part of the toothbrush handle.

In another electric toothbrush, the data transmission takes place by way of a specific data transmission interface which is additionally provided on the toothbrush and is compatible with an external terminal, e.g., via a standard wireless USB interface.

A variety of data can be transmitted over the aforementioned interfaces from the external data processing unit to the toothbrush or vice versa. In particular, control of the toothbrush can be individualized, modified and/or supplemented. For example, a desired language for user guidance or a timer signal may be selected and corresponding control data entered into a control unit in the toothbrush. Alternatively or additionally, display graphics and texts as well as timer melodies may be transmitted to the control unit of the toothbrush. Alternatively or additionally, a software update may also be transferred to the control unit of the toothbrush.

Alternatively or additionally, tooth-brushing data and/or operating data determined and/or stored by the control unit of the toothbrush may be transmitted to the external data processing and/or display unit. For example, a tooth-brushing history and/or tooth-brushing statistics including, for example, the duration of tooth-brushing and/or the contact pressure in tooth-brushing can be transferred to the external data processing and/or display unit to be analyzed graphically or otherwise there. For example, a dentist or analytical software installed in the data processing unit may give recommendations for improvement of the brushing performance on the basis of the data thereby transferred.

The present invention is explained in greater detail below on the basis of a preferred exemplary embodiment which is depicted in the drawings. Additional details are described in the description.

### BRIEF DESCRIPTION OF THE DRAWINGS

FIG. 1 shows a schematic diagram of an electric toothbrush and an adapter for data transmission between the electric toothbrush and in external data processing and/or display unit, and

FIG. 2 shows a block diagram of the function components for data transmission between a control unit of the electric toothbrush and an external data processing and/or display unit.

### DETAILED DESCRIPTION

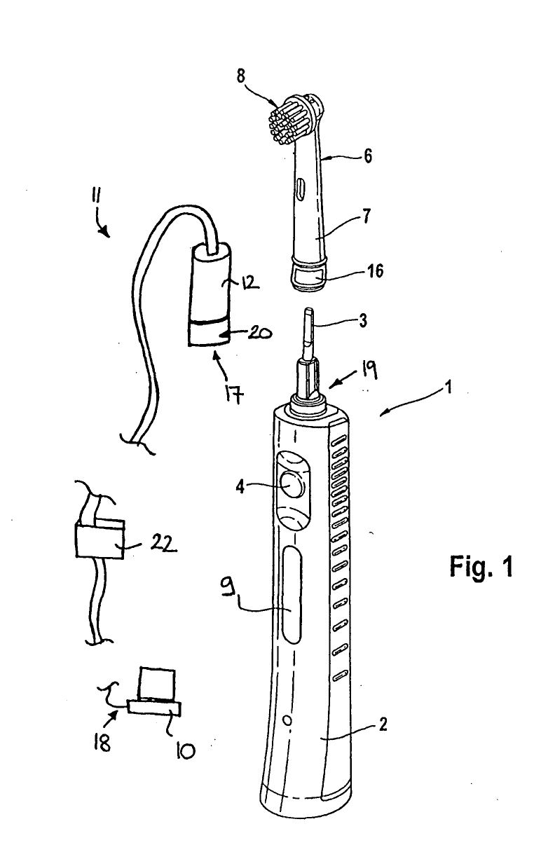

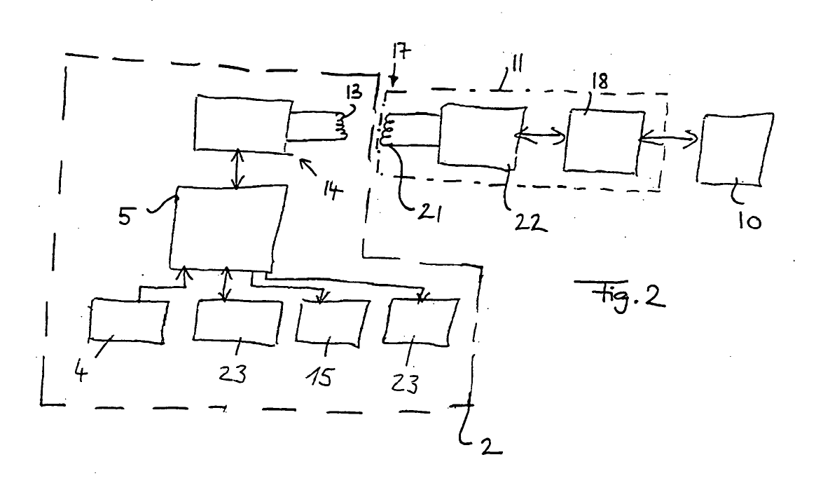

The electric toothbrush 1 illustrated in FIG. 1 includes an attachable brush 6 and a handle 2 which contains a drive motor driving a drive shaft 3 protruding out of the handle 2 at the end. In addition, the handle 2 contains an electronic control unit 5 (see FIG. 2) that controls the operation of the toothbrush 1 and to this end is connected to an on/off switch 4 and a drive motor 15. The electric toothbrush may additionally have one or more displays 23 (see FIG. 2). The replaceable attachable brush 6, which has a brush tube 7 having a bristle field 8, may be attached to the drive shaft 3.

As diagrammed schematically in FIG. 1, a transponder 16 with a data memory in which various data can be stored is provided on the attachable brush 6, said data including, for example, the identification data identifying the attachable brush, tooth-brushing data, e.g., the cumulative brushing time of the attachable brush or control data provided for the specific attachable brush for controlling the toothbrush drive. To be able to transmit data from the data memory to the handle 2 and/or vice versa, the transponder 16 includes essentially known data transmission means with an antenna, preferably in the form of a coil 21.

The electronic control unit 5 in the handle 2 is connected to a data transmission unit 14 which is also connected to an antenna coil 13. The handle 2 and/or the electronic control unit 15 can therefore send data to the transponder 16 in the attachable brush 6 and/or conversely receive data from it. The data transmission unit 14 and the antenna 13 thus form an interface provided for data communication between the handle 2 and the attachable brush 6.

In addition, the handle 2 may be embodied to receive an application substance container in the form of a toothpaste bag 9 which can be connected to a delivery unit (not shown in the figure) in the handle 2 to deliver toothpaste stored in the toothpaste bag 9 to the bristle field 8. The toothbrush bag 9 may also be provided with a transponder having a data memory and an antenna, and the handle may have another data transmission unit and an antenna over which the handle 2 and/or the electronic control unit 5 can send data to the transponder in the application substance container and/or conversely receive data from it.

The adapter 11, which is also shown in FIG. 1, is designed for the toothbrush 1 to communicate via its interface(s) with an external data processing and/or display unit 10, e.g., a PC. To this end, instead of the attachable brush or the toothpaste bag 9 being attached to the handle 2 of the electric toothbrush 1, the adapter 11 is attached there. The adapter 11 has a toothbrush interface 17, which is compatible with the interface of the handle on the one hand and has a terminal interface 18 which is compatible with the external data processing and/or display unit 10, e.g., a USB interface or an essentially known wireless USB interface, on the other hand.

The adapter 11 contains a coupling piece 12 which is connectable in a form-fitting and/or frictionally locked manner to the attachable brush coupling part 19 of the handle 2 to which the attachable brush 6 is otherwise connected. The coupling piece may also be adapted to a toothpaste bag coupling part of the handle. In the case of data transmission by high-frequency electromagnetic waves, a modulator/demodulator 22, which can communicate with the data transmission unit 14 of the toothbrush 1, is preferably provided in the coupling piece 12 of the adapter 11. The modulator/demodulator 22 is connected to an antenna coil 21 (see FIG. 2).

Data transmission between the handle 2 of the electric toothbrush and the external data processing and/or display device 10 and/or the attachable brush 6 or the application substance container 9 is preferably accomplished in a known way, for example, by means of a high-frequency carrier signal modulated with an information signal. For example, the data transmission unit 14 in the handle 2 generates a carrier signal with a frequency of 13.56 MHz, for example, which is modulated with an information signal of approx. 212 kHz for example. The modulator/demodulator 22 arranged in the adapter 11 demodulates the signal transmitted from the handle 2 and relays the information signal to the external data processing and/or display device 10. For data transmission in the opposite direction, the modulator/demodulator 22 short-circuits its antenna coil 21 in the clock cycle of the information signal to be transmitted. However, the data transmission unit 14 in the handle 2 generates an unmodulated high-frequency carrier signal from which power is withdrawn by the short-circuited antenna coil 21 of the adapter 11 in the clock cycle of the information signal to be transmitted, i.e., the carrier signal is amplitude-modulated with the information signal in this way. After successful demodulation, the data transmission unit 14 in the handle 2 relays the information signal to the control unit 5.

In another electric toothbrush (not shown in the figures) data transmission takes place between the electric toothbrush and the external data processing and/or display unit without an adapter, e.g., using the essentially known wireless USB standard in the frequency range of 2.4 GHz. This toothbrush then has a suitable data transmission interface for this purpose.

1-14. (canceled)

15. An electric toothbrush and communication system, comprising
a motorized toothbrush handle having a releasable coupling configured to receive a replaceable toothbrush attachment, the handle including a data transmission interface configured for data communication between the handle and the attachment; and
a toothbrush data transmission adapter, comprising
a toothbrush coupling configured to be coupled with the handle so as to communicate with the data transmission interface of the toothbrush handle; and
a terminal interface in communication with the toothbrush coupling and configured to connect to an external terminal to enable data transmission between the toothbrush handle and the terminal.

16. The electric toothbrush and communication system of claim 15, wherein the replaceable toothbrush attachment comprises a brush head.

17. The electric toothbrush and communication system of claim 15, wherein the replaceable toothbrush attachment comprises an application substance container.

18. The electric toothbrush and communication system of claim 15, wherein the releasable coupling of the toothbrush handle is configured to receive the toothbrush coupling of the adapter.

19. The electric toothbrush and communication system of claim 18, wherein the toothbrush coupling of the adapter is configured to be received on the releasable coupling of the toothbrush handle in a form-fitting or frictionally locked manner.

20. The electric toothbrush and communication system of claim 15, wherein the data transmission interface of the toothbrush handle has no exposed electrical contacts.

21. The electric toothbrush and communication system of claim 15, wherein the terminal interface comprises a USB interface or wireless USB interface.

22. A toothbrush data transmission adapter, comprising
a toothbrush coupling configured to be coupled with an electric toothbrush handle having a data transmission interface configured to communicate with a replaceable toothbrush attachment, the toothbrush coupling including a toothbrush data interface configured to communicate with a data transmission interface of a toothbrush handle to which the coupling is coupled; and
a terminal interface in communication with the toothbrush coupling and configured to connect to an external terminal to enable data transmission between the toothbrush handle and the terminal.

23. The adapter of claim 22, wherein the toothbrush data interface has no exposed electrical contacts.

24. The adapter of claim 22, wherein the toothbrush data interface comprises an antenna.

25. The adapter of claim 22, wherein the toothbrush coupling is configured to be received on a replaceable brush head coupling of an electric toothbrush handle.

26. An electric toothbrush having a data transmission unit and an interface for data transmission between the electric toothbrush and an external terminal, characterized in that
the interface corresponds to a wireless USB standard.

27. A method of transmitting data between an electric toothbrush handle and a terminal, the method comprising
connecting the toothbrush handle to the terminal via a data coupling that includes a coil in the toothbrush handle and a corresponding coil external to the toothbrush handle; and
establishing data communication between the toothbrush handle and the terminal through the data coupling.

28. The method of claim 27, wherein connecting the toothbrush handle to the terminal comprises physically connecting the toothbrush handle to a coupling that includes the corresponding coil, such that the corresponding coil is brought into proximity with the coil in the toothbrush handle.

29. The method of claim 27, wherein the coupling is at one end of an adaptor that comprises a terminal interface at an opposite end thereof, the terminal interface of the adapter configured for interfacing with the terminal.

30. The method of claim 29, further comprising, prior to connecting the toothbrush handle to the terminal, removing a replaceable toothbrush attachment from the handle to expose a releasable coupling of the handle, and wherein connecting the toothbrush handle to the terminal comprises connecting the coupling at the end of the adapter to the releasable coupling of the handle.

31. The method of claim 27, wherein the coil in the toothbrush handle is adjacent a releasable coupling configured to receive a replaceable toothbrush attachment.

32. The method of claim 27, wherein the data coupling comprises an interface also configured for data transmission between the toothbrush handle and a replaceable toothbrush attachment.

33. The method of claim 27, wherein the data communication is established wirelessly.

34. The method of claim 33, wherein the data communication is established according to a wireless USB standard.
